(19) United States
(12) Patent Application Publication
(10) Pub. No.: US 2007/0152368 A1
(43) Pub. Date: Jul. 5, 2007

(54) Method of modifying cyclic olefin copolymer using reactive extrusion

(75) Inventors: Cheol Ho Choi, Gyeonggi-do (KR); Joon Sik Shin, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Suwon-si (KR)

(21) Appl. No.: 11/326,227

(22) Filed: Jan. 4, 2006

(51) Int. Cl. B29C 47/60

(52) U.S. Cl. 264/211.23; 264/211.24

(57) ABSTRACT

The present invention relates to a method of modifying a cyclic olefin copolymer, in which a monomer having at least one unsaturated carboxyl group is grafted onto a main chain of the cyclic olefin copolymer using reactive extrusion. The cyclic olefin copolymer is modified so as to have at least one hydrophilic functional group, thereby having improved adhesion strength. Synthesis is conducted through a continuous process in an extruder, thus it is possible to modify the cyclic olefin copolymer through an economical and effective process.

### BACKGROUND OF THE INVENTION

1. Field of the Invention

The present invention relates to a method of modifying a cyclic olefin copolymer using reactive extrusion. More particularly, the present invention pertains to a method of modifying a cyclic olefin copolymer using reactive extrusion, in which a monomer having at least one hydrophilic group is grafted onto a main chain of the cyclic olefin copolymer using reactive extrusion to improve adhesion strength of the cyclic olefin copolymer.

2. Description of the Related Art

Generally, polyolefins (polymers including C and H, such as polyethylene and polypropylene) have excellent mechanical and electrical properties, thus being used for various purposes. Particularly, since they have a simple structure and excellent processability, they are frequently used to produce films, vessels, and vinyl bags, and also extensively used in a study of polymer processing fields, such as extrusion or injection.

In polyolefins, ultra-high molecular weight polyethylene, having a molecular weight of several million or more, has excellent mechanical properties. Particularly, if a polymer chain is oriented through stretching, the mechanical properties are increased to a few tens to a few hundreds GPa, thus it is expected to be variously applied. However, since polyethylene or ultra-high molecular weight polyolefins are nonpolar, they have poor compatibility and adhesion to polar matrices, such as nylon, polyester, aluminum, iron, paper, and wood, and even to polyolefins having the same polarity, thus they are used within a limited range.

Meanwhile, in the case of a cyclic olefin copolymer (COC) which is copolymerized along with polyolefins, transparency is excellent and electric properties are fair, thus many studies have been conducted to use it as an optical storage material instead of polycarbonates. Moreover, it is expected that the copolymer can be used as an insulating material applied to a substrate.

With respect to this, many conventional studies have been conducted to modify non-adhesion property of polyolefins, particularly, polyethylene.

For example, U.S. Pat. No. 4,612,155 discloses a method of conducting continuous grafting in the presence of a maleic anhydride component, and suggests a type and content of components with respect to this method in views of rheological properties.

Furthermore, U.S. Pat. No. 4,762,890 discloses a grafting method in which maleic anhydride and an initiator are dissolved in a solvent and then injected into a twin screw extruder using a liquid injection device.

In another method, in order to give polyethylene adhesion strength, peroxides are precipitated onto a film having a thickness of 1 mm, irradiation is conducted, the resulting film is dipped into a methyl methacrylate (MMA) solution, and MMA is polymerized on the ultra-high molecular weight polyethylene film.

However, the above-mentioned conventional methods are disadvantageous in that a processing time is long, various costs are required, and a process is complicated, thus production cost is high. Meanwhile, in the case of low molecular weight polyethylene (LMWPE) having a low molecular weight, it is relatively easy to conduct modification using MAH (maleic anhydride) or MMA (methyl methacrylate) through reactive extrusion. However, this process has not been conducted using a cyclic olefin copolymer.

### SUMMARY OF THE INVENTION

The present inventor has conducted extensive studies into avoidance of the above-mentioned problems of the conventional technology, resulting in the finding that, when a hydrophilic group is introduced into a cyclic olefin copolymer through a continuous process using a reactive extrusion method, which is considered a method of synthesizing a polymer at low cost, it is possible to improve adhesion strength of the cyclic olefin copolymer, thereby accomplishing the present invention.

Accordingly, an object of the present invention is to provide a method of modifying a cyclic olefin copolymer using reactive extrusion, in which adhesion strength of the cyclic olefin copolymer is improved through an economical and effective process.

In order to accomplish the above object, the present invention provides a method of modifying a cyclic olefin copolymer. The method includes mixing 5-50 parts by weight of grafting monomer having at least one unsaturated carboxyl group and 0.1-20 parts by weight of reaction initiator based on 100 parts by weight of cyclic olefin copolymer to form a mixture having the cyclic olefin copolymer at 0-35° C.; and feeding a mixture into a twin screw extruder to extrude the mixture at 120-140° C. so that a grafting reaction is achieved.

In connection with this, extrusion duration is 1-60 min.

In an embodiment, the cyclic olefin copolymer has a glass transition temperature (Tg) of 70-400° C.

The grafting monomer can be selected from the group consisting of unsaturated carboxylic acid monomers, ethylene-based unsaturated carboxylic acid esters, and ethylene-based unsaturated carboxylic acid anhydrides.

In another embodiment, the grafting monomer is selected from the group consisting of an acrylic acid, a methacrylic acid, an ethacrynic acid, a maleic acid, a fumaric acid, glycidyl methacrylate, methyl methacrylate, 2-hydroxyethyl acrylate, 2-hydroxyethyl methacrylate, monoethyl maleate, diethyl maleate, di-n-butyl maleate, maleic anhydride, 5-norbornene-2,3-anhydride, and nadic anhydride.

In one embodiment, the grafting monomer is methyl methacrylate.

In a further embodiment, the grafting monomer is maleic anhydride.

The reaction initiator can be selected from the group consisting of acyl peroxides, dialkyl or aralkyl peroxides, peroxy esters, hydroperoxides, ketone peroxides, and an azo compound.

Additionally, the reaction initiator can be selected from the group consisting of benzoyl peroxide, di-t-butyl peroxide, dicumyl peroxide, cumyl butyl peroxide, 1,1-di-t-butylperoxy-3,5,5-trimethylcyclohexane, 2,5-dimethyl-2,5-di-t-butylperoxy hexane, bis(t-butylperoxyisopropyl)benzene, t-butyl peroxypivalate, t-butyl di(perphthalate), dialkyl peroxymonocarbonate, peroxydicarbonate, t-butyl perbenzoate, 2,5-dimethylhexyl-2,5-di(perbenzoate), t-butyl peroctoate, t-butyl hydroperoxide, p-methane hydroperoxide, pinane hydroperoxide, cumene hydroperoxide, cyclohexanone peroxide, methylethylketone peroxide, and azobisisobutyronitrile.

In an embodiment, the reaction initiator is dicumyl peroxide.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a FT-IR graph of a cyclic olefin copolymer which is modified according to example 1 of the present invention.

### DETAILED DESCRIPTION OF THE INVENTION

Hereinafter, a detailed description will be given of the present invention.

As described above, the present invention provides a method of modifying a cyclic olefin copolymer using a reactive extrusion method, which is considered a method of synthesizing a polymer at low cost. In the method, a monomer having at least one hydrophilic group is grafted onto a main chain of the cyclic olefin copolymer so as to assure excellent adhesion strength.

The method of modifying the cyclic olefin copolymer according to the present invention includes mixing 5-50 parts by weight of grafting monomer having at least one unsaturated carboxyl group and 0.1-20 parts by weight of reaction initiator based on 100 parts by weight of cyclic olefin copolymer at normal temperature (i.e. 0-35° C.).

In connection with this, mixing temperature is preferably 0-35° C. If the temperature is lower than 0° C., portions of both the initiator and the monomer are subjected to phase transition, and, if the temperature is higher than 35° C., the initiator may be reacted first.

In an embodiment the cyclic olefin copolymer of the present invention can have a glass transition temperature (Tg) of 70-400° C., and may be exemplified by compounds including norbornene and ethylene as a polymerization unit. However, it is not limited to the above examples. In connection with this, if Tg of the cyclic olefin copolymer deviates from the above-mentioned range, it is difficult to apply to the process.

Examples of the grafting monomer used in the present invention include unsaturated carboxylic acid monomers, ethylene-based unsaturated carboxylic acid esters, and ethylene-based unsaturated carboxylic acid anhydrides.

The grafting monomer is exemplified by unsaturated carboxylic acids, such as an acrylic acid, a methacrylic acid, an ethacrynic acid, a maleic acid, and a fumaric acid; ethylene-based unsaturated carboxylic acid esters, such as glycidyl methacrylate, methyl methacrylate, 2-hydroxyethyl acrylate, 2-hydroxyethyl methacrylate, monoethyl maleate, diethyl maleate, and di-n-butyl maleate; and ethylene-based unsaturated carboxylic acid anhydrides, such as maleic anhydride, 5-norbornene-2,3-anhydride, and nadic anhydride.

In an embodiment the grafting monomer can be methyl methacrylate or maleic anhydride.

In connection with this, the amount of grafting monomer used is preferably 5-50 parts by weight based on 100 parts by weight of cyclic olefin copolymer. If the amount is less than 5 parts by weight, modification of the cyclic olefin copolymer is insufficiently achieved, thus undesirable adhesion strength is assured. If the amount is more than 50 parts by weight, an excessive amount of ungrafted monomers remain in the cyclic olefin copolymer, causing a reduction in adhesion strength and in other physical properties.

In the present invention, examples of the reaction initiator, which is used to graft the grafting monomer on the cyclic olefin copolymer, include acyl peroxides, dialkyl or aralkyl peroxides, peroxy esters, hydroperoxides, ketone peroxides, and an azo compound.

Preferably, acyl peroxides are exemplified by benzoyl peroxide, and dialkyl or aralkyl peroxides are exemplified by di-t-butyl peroxide, dicumyl peroxide, cumyl butyl peroxide, 1,1-di-t-butylperoxy-3,5,5-trimethylcyclohexane, 2,5-dimethyl-2,5-di-t-butylperoxy hexane, and bis(t-butylperoxyisopropyl)benzene. Furthermore, examples of peroxy esters include t-butyl peroxypivalate, t-butyl di(perphthalate), dialkyl peroxymonocarbonate, peroxydicarbonate, t-butyl perbenzoate, 2,5-dimethylhexyl-2,5-di(perbenzoate), and t-butyl peroctoate. Examples of hydroperoxides include t-butyl hydroperoxide, p-methane hydroperoxide, pinane hydroperoxide, and cumene hydroperoxide, examples of ketone peroxides include cyclohexanone peroxide and methylethylketone peroxide, and the azo compound is exemplified by azobisisobutyronitrile.

In an embodiment the reaction initiator can be dicumyl peroxide.

In connection with this, the amount of reaction initiator used is preferably 0.1-20 parts by weight based on 100 parts by weight of cyclic olefin copolymer. If the amount is less than 0.1 parts by weight, since the monomer is insufficiently grafted onto a main chain of the cyclic olefin copolymer, undesirable adhesion strength is assured, and an excessive amount of unreacted monomer may remain in the cyclic olefin copolymer depending on correlation with the monomer. On the other hand, if the amount is more than 20 parts by weight, fluidity of the cyclic olefin copolymer is poor due to a rapid increase in melt viscosity.

The modification method of the present invention includes feeding the above-mentioned mixture into a twin screw extruder, a temperature of which is preliminarily set, and conducting melt-mixing and extrusion through a continuous process to achieve a grafting reaction.

An extrusion temperature is preferably 120-400° C. If the extrusion temperature is lower than 120° C., the cyclic olefin copolymer is undesirably melted, thus the grafting reaction is undesirably conducted, and, if the temperature is higher than 400° C., a crosslinking reaction increases, causing an increase in melt viscosity of the modified cyclic olefin copolymer.

In connection with this, configuration of a screw of the twin screw extruder is controlled to adjust extrusion duration, thereby it is possible to improve grafting reactivity. With respect to this, the extrusion duration is 1-60 min, and preferably 5-30 min. If the extrusion duration is shorter than 1 min, the grafting reaction is insufficiently conducted, thus it is impossible to obtain improved adhesion strength. If the duration is longer than 1 hour, decomposition occurs.

In order to remove impurities, the extruded material is dissolved in hot xylene, precipitated in cold acetone, and dried at a predetermined temperature to produce the modified cyclic olefin copolymer, which includes a hydrophilic group and thus has excellent adhesion strength.

In the present invention, as described above, a monomer having at least one unsaturated carboxyl group, such as —COOH or —COOCH₃, as the hydrophilic functional group is grafted onto an ethylene portion of the main chain in order to provide hydrogen bonding components to the cyclic olefin copolymer, thereby creating the modified cyclic olefin copolymer having excellent adhesion strength.

The grafting of the modified cyclic olefin copolymer can be confirmed by checking a hydrogen bond group of the COC which is grafted with a monomer capable of providing a hydrogen bond using FT-IR (Fourier Transform Infra-red).

As described above, in the present invention, the monomer having the hydrophilic functional group including a —COOH functional group is grafted onto the cyclic olefin copolymer using reactive extrusion to improve adhesion properties of the cyclic olefin copolymer using the hydrogen bond, thereby the modification is achieved. Furthermore, synthesis is conducted at a time through a continuous process in an extruder, thus it is possible to easily produce a lot of modified cyclic olefin copolymer through an economical and effective process at low cost.

The cyclic olefin copolymer may be used as toner binder resins, medical packages, optical applications, capacitor films, and insulating materials for a substrate according to a Tg range thereof and a compositional ratio when it is blended with other polymers. Currently, a melt processing method is mostly used to process the cyclic olefin copolymer, and it may be processed into fibers or films through this method.

A better understanding of the present invention may be obtained through the following examples which are set forth to illustrate, but are not to be construed as the limit of the present invention.

### EXAMPLE 1

20 parts by weight of MMA and 10 parts by weight of DCP (dicumyl peroxide) were agitated at about 25° C. based on 100 parts by weight of COC having Tg of 300° C., and then fed into a twin screw extruder. They were extruded at an extrusion temperature of about 250-300° C. for about 15 min, dissolved in hot xylene, and precipitated in cold acetone to remove impurities. The resulting precipitate was dried at about 60° C. to produce modified COC.

### EXAMPLE 2

20 parts by weight of MAH and 10 parts by weight of DCP (dicumyl peroxide) were agitated at about 25° C., based on 100 parts by weight of COC having Tg of 300° C., and then fed into a twin screw extruder. They were extruded at an extrusion temperature of about 250-300° C. for about 15 min, dissolved in hot xylene, and precipitated in cold acetone to remove impurities. The resulting precipitate was dried at about 60° C. to produce modified COC.

### EXAMPLE 3

20 parts by weight of MMA and 10 parts by weight of BZP (benzoyl peroxide) were agitated at about 25° C., based on 100 parts by weight of COC having Tg of 300° C., and then fed into a twin screw extruder. They were extruded at an extrusion temperature of about 250-300° C. for about 15 min, dissolved in hot xylene, and precipitated in cold acetone to remove impurities. The resulting precipitate was dried at about 60° C. to produce modified COC.

### EXAMPLE 4

20 parts by weight of methacrylic acid and 10 parts by weight of BZP (benzoyl peroxide) were agitated at about 25° C., based on 100 parts by weight of COC having Tg of 300° C., and then fed into a twin screw extruder. They were extruded at an extrusion temperature of about 250-300° C. for about 15 min, dissolved in hot xylene, and precipitated in cold acetone to remove impurities. The resulting precipitate was dried at about 60° C. to produce modified COC.

### EXAMPLE 5

Confirmation of Grafting

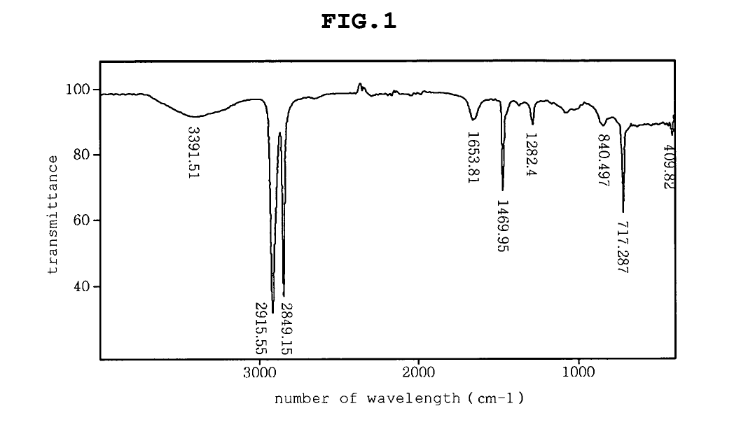

A hydrogen bond group of a cyclic olefin copolymer (COC), onto which MMA (methyl methacrylate) and MAH (maleic anhydride) as monomers capable of providing a hydrogen bond were grafted, was confirmed using FT-IR (Fourier Transform Infra-red). A ratio of absorbance of a CH₂ peak shown at 760-680 cm⁻¹ to absorbance of a C═O (carbonyl) peak shown at 1735 cm⁻¹ was calculated to quantitatively confirm the amount of MMA grafted onto the COC. Furthermore, a ratio of absorbance of a CH₂ peak shown at 760-680 cm⁻¹ to absorbance of C═O (carbonyl) peaks shown at 1830-1750 cm⁻¹ and at 1750-1660 cm⁻¹ was calculated to quantitatively confirm how much MAH was grafted onto the COC. The measurement results of absorbance are shown in FIG. 1.

### EXAMPLE 6

Test of Adhesion Strength

In order to measure adhesion strengths of samples, the samples were pressed using a uniaxial press at 300° C. for 3 min to achieve adhesion, and adhesion strengths were measured using a push-pull gauge. The measured adhesion strengths are as follows.

TABLE 1

| Example | Peeling strength (kgf/cm) |
|---|---|
| 1 | 210 |
| 2 | 250 |
| 3 | 320 |
| 4 | 350 |

Generally, adhesion strength of the COC is 100 kgf/cm or less before modification. On the other hand, from Table 1 it can be seen that the COC modified according to the present invention had strength of 210-350 kgf/cm, thus adhesion strength was improved.

As described above, in the present invention, a cyclic olefin copolymer including a unsaturated carboxyl group is mass-produced using reactive extrusion to reduce production cost of a raw material and to graft a hydrophilic group onto an olefin main chain, thereby it is possible to produce the modified cyclic olefin copolymer having improved adhesion strength, due to a hydrogen bond.

Furthermore, the cyclic olefin copolymer, which is modified according to a method of the present invention, is applied to an insulating material of a substrate through extrusion and stretching processes to provide excellent adhesion strength between sheets.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method of modifying a cyclic olefin copolymer, comprising the steps of:
mixing 5-50 parts by weight of a grafting monomer having at least one unsaturated carboxyl group and 0.1-20 parts by weight of a reaction initiator based on 100 parts by weight of a cyclic olefin copolymer to form a mixture having the cyclic olefin copolymer at 0-35° C.;
feeding the mixture into a twin screw extruder; and
extruding the mixture at 120-140° C. so that a grafting reaction is achieved.

2. The method as set forth in claim 1, wherein the extruding step has an extrusion duration of 1-60 min.

3. The method as set forth in claim 1, wherein the extruding step has an extrusion duration of 5-30 min.

4. The method as set forth in claim 1, wherein the cyclic olefin copolymer has a glass transition temperature (Tg) of 70-400° C.

5. The method as set forth in claim 1, wherein the grafting monomer is unsaturated carboxylic acid monomers, ethylene-based unsaturated carboxylic acid esters, ethylene-based unsaturated carboxylic acid anhydrides, an acrylic acid, a methacrylic acid, an ethacrynic acid, a maleic acid, a fumaric acid, glycidyl methacrylate, methyl methacrylate, 2-hydroxyethyl acrylate, 2-hydroxyethyl methacrylate, monoethyl maleate, diethyl maleate, di-n-butyl maleate, maleic anhydride, 5-norbornene-2,3-anhydride, or nadic anhydride.

6. The method as set forth in claim 1, wherein the grafting monomer is methyl methacrylate.

7. The method as set forth in claim 1, wherein the grafting monomer is maleic anhydride.

8. The method as set forth in claim 1, wherein the reaction initiator is acyl peroxides, dialkyl or aralkyl peroxides, peroxy esters, hydroperoxides, ketone peroxides, an azo compound, benzoyl peroxide, di-t-butyl peroxide, dicumyl peroxide, cumyl butyl peroxide, 1,1-di-t-butylperoxy-3,5,5-trimethylcyclohexane, 2,5-dimethyl-2,5-di-t-butylperoxy hexane, bis(t-butylperoxyisopropyl)benzene, t-butyl peroxypivalate, t-butyl di(perphthalate), dialkyl peroxymonocarbonate, peroxydicarbonate, t-butyl perbenzoate, 2,5-dimethylhexyl-2,5-di(perbenzoate), t-butyl peroctoate, t-butyl hydroperoxide, p-methane hydroperoxide, pinane hydroperoxide, cumene hydroperoxide, cyclohexanone peroxide, methylethylketone peroxide, or azobisisobutyronitrile.

9. The method as set forth in claim 1, wherein the reaction initiator is dicumyl peroxide.
